(19) United States
(12) Patent Application Publication
(10) Pub. No.: US 2024/0286878 A1
(43) Pub. Date: Aug. 29, 2024

(54) TRANSPORTATION TOOL, METHOD FOR INTERACTION BETWEEN ROBOT AND TRANSPORTATION TOOL, AND SYSTEM COMPRISING TRANSPORTATION TOOL

(71) Applicant: LINGDONG TECHNOLOGY (BEIJING) CO.LTD., Beijing (CN)

(72) Inventors: Ou QI, Beijing (CN); Jiahong WU, Beijing (CN); Peng CHENG, Beijing (CN)

(21) Appl. No.: 18/574,337

(22) PCT Filed: May 12, 2022
(86) PCT No.: PCT/CN2022/092357

§ 371 Date: Dec. 27, 2023

(30) Foreign Application Priority Data
Jul. 6, 2021 (CN) 202110764175.X

(51) Int. Cl. B66F 9/075; B25J 9/16; B66F 17/00

(52) U.S. Cl. CPC B66F 9/07504; B25J 9/1666; B66F 17/003

(57) ABSTRACT

Disclosed are a transportation tool, a method for interaction between an intelligent mobile robot and the transportation tool, and a system comprising a plurality of transportation tools. The transportation tool comprises a body (101), and a bearing component (102) mounted on the body (101) and extending out of the body (101), where one or more markers (103) is/are formed on the body (101); at least part of the one or more markers (103) are located above the bearing component (102); at least one of the one or more markers (103) forms a code; and the code is used for representing information related to the transportation tool. The transportation tool can be detected and identified more easily and specifically, thereby avoiding or reducing accidents and potential safety hazards that may occur due to defects in detection and identification, and improving the efficiency and safety of interaction between interaction objects, such as the intelligent mobile robot and the transportation tool.

### TECHNICAL FIELD

The present invention relates to the field of transportation tools, in particular to a transportation tool, a method for interaction between an intelligent mobile robot and the transportation tool, a system comprising a plurality of transportation tools, a corresponding computer device, and a corresponding computer-readable storage medium.

### BACKGROUND

In the current intelligent warehousing application, an intelligent mobile robot (such as a logistics vehicle) and a transportation tool (such as a forklift) are used together and even interact with each other. However, the intelligent mobile robot cannot detect the transportation tool, which leads to possible accidents. For example, for the forklift, due to the low height of fork teeth, a Lidar of the logistics vehicle may not detect the fork teeth, thereby causing a collision. In addition, it is difficult to identify the existing transportation tool and detect specific information, resulting in low interaction efficiency of the intelligent mobile robot and the transportation tool, even a certain potential safety hazard.

### SUMMARY

The present application aims to provide a solution to solve or at least alleviate at least some of the above problems.

Specifically, according to a first aspect of the present invention, a transportation tool is provided and comprises:
a body; and
a bearing component, mounted on the body and extending out of the body,
wherein the body comprises one or more markers formed thereon, at least a part of the one or more markers are above the bearing component,
at least one of the one or more markers forms a code, and the code is configured to represent information related to the transportation tool.

According to a second aspect of the present invention, a method for interaction between an intelligent mobile robot and the transportation tool according to the first aspect is provided, and comprises the following steps performed by the intelligent mobile robot:
a detection step, comprising: detecting the at least one marker to detect the transportation tool and identify information related to the transportation tool; and
a processing step, comprising: performing an operation based on the identified information in response to the transportation tool being detected.

According to a third aspect of the present invention, a system comprising a plurality of transportation tools is provided, where each of the plurality of transportation tools is the transportation tool according to the first aspect.

According to a fourth aspect of the present invention, a computer device is provided, and comprises a memory and a processor, where the memory stores a computer instruction, and when executed by the processor, the computer instruction causes the steps comprised in the method according to the second aspect to be performed.

According to a fifth aspect of the present invention, a non-transitory computer-readable storage medium is provided, where a computer instruction is stored in the non-transitory computer-readable storage medium, and when executed by a processor, the computer instruction causes the steps comprised in the method according to the second aspect to be performed.

According to the present invention, the body of the transportation tool has at least one marker located above the bearing component, and at least one marker forms a code to represent information related to the transportation tool. In this way, the marker on the transportation tool can be detected to detect the transportation tool and identify the information related to the transportation tool. By adoption of the solution of the present invention, the transportation tool can be detected and identified more easily and specifically, thereby avoiding or reducing accidents and potential safety hazards that may occur due to defects in detection and identification, and improving the efficiency and safety of interaction between interaction objects, such as the intelligent mobile robot and the transportation tool.

### BRIEF DESCRIPTION OF THE DRAWINGS

Non-restrictive and non-exhaustive embodiments of the present invention are described by way of examples with reference to the following drawings.

FIG. 1 schematically shows a diagram of a forklift according to an embodiment of the present invention;

FIG. 2 schematically shows a flowchart of a method for interaction between an intelligent mobile robot and a transportation tool according to an embodiment of the present invention; and

FIG. 3 schematically shows a flowchart of a processing step involved in a method in FIG. 2.

### DETAILED DESCRIPTION OF EMBODIMENTS

To make the above and other features and advantages of the present invention clearer, the present invention is further described below with reference to the accompanying drawings. It should be understood that the specific embodiments given here are for the purpose of explaining to those skilled in the art, which are only exemplary and not restrictive.

In the following description, numerous details are elaborated to provide a thorough understanding of the present invention. However, it will be apparent to those of ordinary skill in the art that the specific details are not required to implement the present invention. In other cases, the well-known steps or operations are not described to prevent the present invention from being obscured.

The “transportation tool” mentioned in the present invention should be broadly understood as comprising vehicles with carrying capacity and used in various environments, comprising, for example, but not limited to various vehicles suitable for being used in warehousing and logistics industries to perform tasks such as material transportation, carrying, loading and unloading, for example, a forklift and other types of logistics vehicles. The transportation tool usually has a body such as a vehicle body, and a bearing component mounted on the body and extending out of the body, such as fork teeth of the forklift, and may optionally have other components. The bearing component is usually mounted on one face of the transportation tool and extends out of the face. For convenience, in the specification, a face of the body of the transportation tool on which the bearing component is mounted is referred to as a front face, a face of the body opposite to the front face is referred to as a rear face, and two faces of the body adjacent to the front face are referred to as a left face or a right face, respectively. Specifically, with respect to an extending direction of the bearing component extending out of the front face, a face on a left side of the front face and adjacent to the front face is referred to as a left face or a left side face, and a face on a right side of the front face and adjacent to the front face is referred to as a right face or a right side face. In the specification, the “face” of the transportation tool or the body thereof may refer to all faces of the transportation tool or the body thereof except a top face and a bottom face usually in a normal or conventional state when the transportation tool is used normally or not used.

The “intelligent mobile robot” mentioned in the present invention may also be referred to as an “intelligent robot”, a “robot” and an “automatic guide vehicle”, and should be broadly understood as comprising an autonomous self-driving vehicle used in various environments, comprising but not limited to a mobile robot, such as an automatic navigation mobile robot, an inertial navigation robot, a remote control mobile robot and/or a robot guided by laser targeting, a visual system and/or a road sign. The robot of the present invention may also be regarded as a self-driving vehicle.

In one embodiment, markers are formed on one face of the transportation tool, preferably, formed on a front face of the transportation tool. In other embodiments, markers are formed on a plurality of faces of the transportation tool, for example, more of a front face, a left face, a right face and a rear face, preferably, formed on each of four faces of the transportation tool. In a case where the front face of the transportation tool has markers, it is advantageous that the marker is located above a bearing component; and in a case where other faces of the transportation tool such as the left face, the right face and/or the rear face have markers, the markers may be located above the bearing component or below the bearing component. In one embodiment, the transportation tool has markers on a plurality of faces, and these markers are located above the bearing component and located at the same height. One face of the transportation tool may have one or more markers.

In one embodiment, at least part of markers on the body of the transportation tool are located above the bearing component, and at least one marker forms a code, respectively. The code is used for representing information related to the transportation tool. The information related to the transportation tool may comprise, for example, but not limited to: identity information for identifying the identity of the transportation tool; and face information for identifying each of at least one face of the body of the transportation tool. Herein, the identity information of the transportation tool should be broadly understood as comprising all kinds of information that may be related to the identity of the transportation tool, comprising, for example, but not limited to: information that can uniquely identify the transportation tool, such as the serial number and ID of the transportation tool; and other possible identity-related information of the transportation tool, such as the model and manufacturer of the transportation tool. It is possible that the identity information of the transportation tool may refer to any information of the transportation tool, according to which an object (such as an intelligent mobile robot) scheduled or suitable for interacting with the transportation tool can determine whether the transportation tool is a target object to interact with, and the information which the information refers to and comprises depends on the specific situation. For example, in one embodiment, the intelligent mobile robot is configured to dock with a forklift of a certain specific type, regardless of the serial number or other aspects of the forklift; and in this case, the identity information of the forklift comprises the model of the forklift, and the intelligent mobile robot can determine the forklift as the target docking object when identifying the forklift of the specific model. For another example, in another embodiment, the intelligent mobile robot is configured to dock with a forklift of a certain specific serial number; and in this case, the identity information of the forklift comprises the serial number of the forklift, and the intelligent mobile robot can determine the forklift as the target docking object only after identifying the forklift of the specific serial number.

In one embodiment, information that is related to the transportation tool and can be represented by the code formed by the marker comprises one or more information items selected from at least one information item associated with the transportation tool. Herein, “information item” may be any information item indicating information of a certain aspect of the transportation tool, comprising, for example, but not limited to an identity information item representing identity information, such as the ID and serial number of the transportation tool, the model of the transportation tool and the manufacturer of the transportation tool.

The markers located on different faces of the body of the transportation tool may be the same or at least partially different, depending on the specific situation. In one embodiment, one transportation tool has a plurality of markers (such as four markers) formed on a plurality of faces (such as four faces) of the transportation tool, respectively. Each of the plurality of markers is composed of a front marker part and a rear marker part. The front marker part of each marker is the same and forms an information item code representing the serial number and/or model of the transportation tool, and the rear marker part of each marker is different and forms a face code representing a face where the marker is located.

Each marker may be formed by, for example, but not limited to one or any appropriate combination of the following: a reflective strip for Lidar, a QR code, a bar code and a v-marker. The code formed by each marker may be in various possible forms, comprising, for example, but not limited to one or any appropriate combination of information representations such as binary codes, numbers and characters. For example, in a case where the marker is formed by the reflective strip for Lidar, the binary code may be represented by the reflective strip with an appropriate width. In one embodiment, in a case where a width of a certain reflective strip is within a first width range, for example, greater than a first width, the reflective strip represents “1” in binary; and in a case where the width of a certain reflective strip is within a second width range different from the first width range, for example, less than the first width, the reflective strip represents “0” in binary. Therefore, a plurality of reflective strips with appropriate width may form a marker representing the required binary code. In a case where the marker is formed by the QR code, according to requirements, the code formed by the marker may be one or any appropriate combination of binary information, numbers and characters that can be represented by the QR code. In a case where the marker is formed by the bar code, the marker may be formed according to a certain coding rule and by setting spaced “strips” and “blanks” with different reflectivities and comprised in the bar code to represent the required code information (such as numbers). In a case where the marker is formed by the v-marker, the marker representing the required code information (such as binary information) may be formed according to an appropriate coding rule and by setting the v-marker arranged in a certain manner. For example, the v-marker may be a v-shaped groove recessed in a face of the transportation tool, and the required code information may be formed by utilizing the size, number and/or relative position relationship of the v-shaped groove forming the marker. Compared with the reflective strip, the v-marker may be more conducive to detection and location by Lidar.

In one embodiment in which the marker forms the binary code, “1” and “0” in the binary are represented by whether there is a specific marker formation (such as a reflective strip) in a fixed area or at a fixed interval. For example, any face of the transportation tool on which a marker is to be formed is divided into four transverse parts with equal width, where each of the transverse parts represents one bit of a four-bit binary number. For each of the transverse parts, in a case where there is a reflective strip in the area of the transverse part, the transverse part represents “1” in the binary; and in a case where there is no reflective strip in the area of the transverse part, the transverse part represents “0” in the binary.

The transportation tool of the present invention may be configured to form a system of the transportation tool. In one embodiment, the system comprises a plurality of transportation tools of the present invention, and each of the transportation tools has four markers formed on four faces of the transportation tool, respectively. For each of the transportation tools, four markers thereon have the same rear marker part and different front marker parts. The same rear marker part forms an information item code representing the serial number and model of the transportation tool, and the front marker part of each marker forms a face code representing a face of the transportation tool where the marker is located. In this case, different transportation tools in the system may have different serial numbers, and have the same or different models. For any two transportation tools in the system, the marker parts (that is, the front marker parts), forming the corresponding face codes, of the markers located on any same face (such as a front face, a rear face, a left face or a right face) may be the same; the marker parts (that is, the rear marker parts), forming the corresponding information codes, of the markers located on any same face (such as a front face, a rear face, a left face or a right face) may be partially different (representing different serial numbers and representing the same model, in case where the two transportation tools have the same model) or may be totally different (representing different serial numbers and representing different models, in a case where the two transportation tools have different models).

In a case of the binary code, the number of bits comprised in the binary code may be determined according to requirements. For example, in a case where the binary code is adopted, the face code may comprise a two-bit binary code. For the information item code, the number of the bits comprised therein may depend on the number of the information items to be represented by the information item code and the number of the bits required to represent each information item. For example, the number of the bits required to represent the serial number of the transportation tool may be determined by the possible maximum serial number; and in a case of the transportation tool system, the possible maximum serial number may be or be based on the number of the transportation tools comprised in the system. For another example, the number of the bits required to represent the model of the transportation tool may be determined by the number of the possible models.

The transportation tool of the present invention is further exemplarily described below by taking a forklift as an example. It should be noted that the features and details described below about the forklift may be suitable for other types of transportation tools.

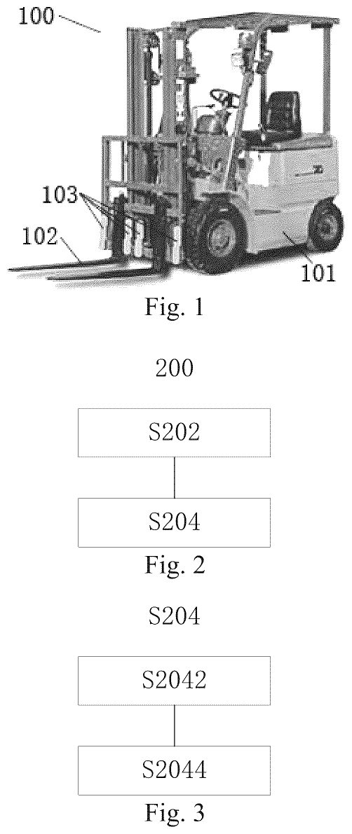

FIG. 1 schematically shows a forklift 100 according to an embodiment of the present invention. The forklift 100 comprises a body 101 and fork teeth 102. Herein, the body 101 may also be referred to as a “vehicle body”, and the fork teeth 102 are a specific form of the bearing component of the transportation tool of the present invention. The body 101 has four faces, namely, a front face, a rear face, a left face and a right face. In FIG. 1, the face of the body 101 where the fork teeth 102 are located is the front face, the face of the body 101 opposite to the front face is the rear face, the face of the body 101 visible in the figure and adjacent to the front face is the left face, and the face of the body 101 invisible in the figure and adjacent to the front face is the right face. The fork teeth 102 are mounted on the front face of the body 101 and extend out of the front face of the body 101. A marker 103 is formed on the front face of the body 101. The marker 103 is located above the fork teeth 102, and comprises a plurality of spaced components for forming a code representing information related to the forklift 100.

In one embodiment, a single forklift has four markers formed on a front face, a rear face, a left face and a right face of the forklift, respectively; the four markers have the same front marker part and different rear marker parts; the same front marker part forms an information item number representing the model of the forklift; and the rear marker part of each of the markers forms a face code representing a face of the forklift where the marker is located. In this case, for a forklift A and a forklift B with a first model, a forklift C with a second model, and a forklift D with a third model, the code formed by the marker located on each face may be shown as the following Table 1.

TABLE 1

| | Front face | Rear face | Left face | Right face |
|---|---|---|---|---|
| Forklift A | 0000 | 0001 | 0010 | 0011 |
| Forklift B | 0000 | 0001 | 0010 | 0011 |
| Forklift C | 0100 | 0101 | 0110 | 0111 |
| Forklift D | 1000 | 1001 | 1010 | 1011 |

As shown in Table 1, for the same forklift, a front face, a rear face, a left face and a right face of the forklift are represented by 00, 01, 10 and 11, respectively, and the codes are formed by the latter half parts of the markers on the corresponding faces; and the model of the forklift are represented by 00, 01 or 10, and the codes are formed by the first half part of the marker on each face of the corresponding forklift.

In another embodiment, a single forklift has four markers formed on a front face, a rear face, a left face and a right face of the forklift, respectively; the four markers have the same front marker part and different rear marker parts; the same front marker part forms an information item code representing the serial number of the forklift; and the rear marker part of each of the markers forms a face code representing a face of the forklift where the marker is located. In this case, for the forklift A, the forklift B, the forklift C and the forklift D, the code formed by the marker located on each face may be shown as the following Table 2.

TABLE 2

| | Front face | Rear face | Left face | Right face |
|---|---|---|---|---|
| Forklift A | 0000 | 0001 | 0010 | 0011 |
| Forklift B | 0100 | 0101 | 0110 | 0111 |
| Forklift C | 1000 | 1001 | 1010 | 1011 |
| Forklift D | 1100 | 1101 | 1110 | 1111 |

As shown in Table 2, for the same forklift, a front face, a rear face, a left face and a right face of the forklift are represented by 00, 01, 10 and 11, respectively, and the codes are formed by the latter half parts of the markers on the corresponding faces; and the code of the forklift are represented by 00, 01, 10 or 11, and the codes are formed by the first half part of the marker on each face of the corresponding forklift.

The forklift A, the forklift B, the forklift C and the forklift D may form a forklift system or a part thereof.

FIG. 2 schematically shows a method 200 for interaction between an intelligent mobile robot and a transportation tool according to an embodiment of the present invention. The method 200 comprises a detection step S202 and a processing step S204.

In the detection step S202, the intelligent mobile robot may detect the markers on the transportation tool to detect the transportation tool and identify information related to the transportation tool. The markers detected by the intelligent mobile robot may comprise at least part of markers on the transportation tool, for example, one or some markers located above the bearing component of the transportation tool, and at least one marker of the code formed on the transportation tool. If necessary, the intelligent mobile robot may move relative to the transportation tool to detect from different angles, thereby realizing more comprehensive detection and information identification.

In the processing step S204, the intelligent mobile robot may perform an operation based on the identified information in response to the transportation tool being detected.

The operation performed in the processing step S204 may comprise one of a plurality of possible operations. These possible operations may be various operations that may be performed by the intelligent mobile robot during interaction with the transportation tool or for the purpose of realizing interaction such as docking according to the situation. The possible operations may be preset, and may comprise, for example, but not limited to a docking operation and an obstacle-avoiding operation.

The intelligent mobile robot may be equipped with various apparatuses/devices required for interaction with the transportation tool to achieve the purpose of interaction such as docking and for detection for interaction, comprising, for example, but not limited to: an apparatus/a device required to perform the docking operation, such as a jacking apparatus, an upper loading platform and a docking apparatus; an apparatus/a device required to perform navigation and movement, such as a movable chassis, a visual sensor and a motion sensor; a laser radar for identifying a reflective strip for Lidar and/or a v-marker that forms a marker; and a camera or a scanner for identifying a QR code and/or a bar code that forms a marker.

When the docking operation or obstacle-avoiding operation is performed, the intelligent mobile robot may consider some available information to appropriately operate and move, for example, planning and following an appropriate docking route or obstacle-avoiding route. The available information may comprise information related to or corresponding to the detected marker or the code represented thereby, and optional other information, for example, other possible information that may be obtained by the intelligent mobile robot in various possible manners (for example, through a sensor such as a visual sensor), such as position information of the forklift.

In one embodiment, the information related to the transportation tool and detected in the detection step S202 comprises identity information for identifying the identity of the transportation tool, and the operation performed in the processing step S204 comprises a docking operation or an obstacle-avoiding operation. In this case, the processing step S204 may comprise a step S2042 and an optional step S2044, as shown in FIG. 3.

In the step S2042, the intelligent mobile robot determines whether the transportation tool is a target docking object of the intelligent mobile robot based on the identified identity information; in a case where the transportation tool is the target docking object of the intelligent mobile robot, the intelligent mobile robot determines that the to-be-performed operation is the docking operation docked with the transportation tool; and in a case where the transportation tool is not the target docking object of the intelligent mobile robot, the intelligent mobile robot determines that the to-be-performed operation is the obstacle-avoiding operation of avoiding the transportation tool.

In the step S2044, the intelligent mobile robot determines the type of the transportation tool, the size of the transportation tool and/or the size of the bearing component based on the identified identity information, and performs the determined to-be-performed operation accordingly. Specifically, in a case where the to-be-performed operation is the docking operation, the intelligent mobile robot performs the docking operation at least partially based on the type of the transportation tool, the size of the transportation tool and/or the size of the bearing component; and in a case where the to-be-performed operation is the obstacle-avoiding operation, the intelligent mobile robot performs the obstacle-avoiding operation at least partially based on the type of the transportation tool, the size of the transportation tool and/or the size of the bearing component. It should be noted here that it is possible to determine the further related information by the identity information of the transportation tool, such as the type of the transportation tool, the size of the transportation tool and the size of the bearing component of the transportation tool.

In another embodiment, in addition to the identity information for identifying the identity of the transportation tool, the information related to the transportation tool and detected in the step S202 further comprises face information for identifying each of at least one face of the body of the transportation tool. In this case, in addition to the step S2042 and the step S2044, the processing step S204 may further and optionally comprise the following steps: the intelligent mobile robot determines the orientation of the transportation tool, the posture of the transportation tool and/or the orientation of the bearing component based on the face information, and performs the determined to-be-performed operation accordingly. Specifically, in a case where the to-be-performed operation is the docking operation, the intelligent mobile robot performs the docking operation at least partially based on the orientation of the transportation tool, the posture of the transportation tool and/or the orientation of the bearing component; and in a case where the to-be-performed operation is the obstacle-avoiding operation, the intelligent mobile robot performs the obstacle-avoiding operation at least partially based on the orientation of the transportation tool, the posture of the transportation tool and/or the orientation of the bearing component. In one embodiment, the posture of the transportation tool may be defined by the xy coordinates of the transportation tool in a rectangular plane coordinate system taking the intelligent mobile robot as an origin, and an included angle between a plane of a certain face detecting the face information in the coordinate system and an x axis and/or a y axis. It should be noted here that it is possible to determine azimuth and orientation information of the transportation tool by the face information of one or more faces of the transportation tool, such as the orientation of the transportation tool, the posture of the transportation tool and the orientation of the bearing component of the transportation tool. Such determination may be implemented through various possible methods, comprising various means known in the prior art. If necessary, when the determination is performed, other available information may be considered, for example, but not limited to position information of the transportation tool relative to the intelligent mobile robot, angle information of a plane of a face detecting the face information relative to the intelligent mobile robot, the physical size of a marker representing the face information, such as a reflective strip, and the position of the marker representing the face information on the corresponding face. As an example, CN110414650A and CN110824494A describe the related contents in this aspect.

For example, in one embodiment relating to a forklift, the intelligent mobile robot detects that the code formed by the marker comprises the identity information of the forklift (for example, the model or serial number of the forklift) by detecting the related marker on the forklift. In a case of determining that the model or serial number of the forklift is consistent with the model or serial number of the target docking forklift, the intelligent mobile robot may determine that the forklift is the target docking forklift to determine to perform the docking operation, and then may plan the docking route and follow the planned docking route to drive to a position docked with the forklift and perform the docking operation to be docked with the forklift. In a case of determining that the model or serial number of the forklift is not consistent with the model or serial number of the target docking forklift, the intelligent mobile robot may determine that the forklift is not the target docking forklift to determine to perform the obstacle-avoiding operation, and then may plan the obstacle-avoiding route and follow the planned obstacle-avoiding route to drive and perform the obstacle-avoiding operation to avoid the forklift.

When the docking route or obstacle-avoiding route is planned, the intelligent mobile robot may consider some available information. For example, according to the detected identity information (such as the model or serial number) of the forklift, the intelligent mobile robot may determine the further information of the forklift. In particular, the intelligent mobile robot may be based on or consider information such as the specific type and size of the forklift, the size of the fork teeth of the forklift and/or the range or area occupied by the forklift when performing the to-be-performed operation such as the docking operation or the obstacle-avoiding operation, and then may plan the docking route or the obstacle-avoiding route by considering the information, for example, based on the information. For another example, according to the detected face information of the forklift, the intelligent mobile robot may determine information related to the azimuth and orientation of the forklift, such as the orientation and posture of the forklift and/or the orientation of the fork teeth of the forklift, and then may plan the docking route or the obstacle-avoiding route by considering the information, for example, based on the information. In addition, if necessary, the position of the fork teeth may be determined, and the docking route or the obstacle-avoiding route may be planned based on the position of the fork teeth. For example, when the intelligent mobile robot detects the face information of the face where the fork teeth are located, the intelligent mobile robot may determine the orientation of the forklift and the orientation of the fork teeth of the forklift by combining with some available information, such as position information of the forklift relative to the intelligent mobile robot and angle information of the plane of the face relative to the intelligent mobile robot. For another example, when the intelligent mobile robot detects the face information of two adjacent faces of the same forklift, the intelligent mobile robot may determine the orientation of the forklift and the orientation of the fork teeth of the forklift by combining with some available information, such as angle information of the plane of each of the two faces relative to the intelligent mobile robot. In one embodiment, the posture of the forklift may be defined by the xy coordinates of the forklift in a rectangular plane coordinate system taking the intelligent mobile robot as an origin, and an included angle between a plane of a face detecting the face information in the coordinate system and an x axis and/or a y axis. For example, in a case where the marker on one or some faces is formed by the reflective strip, the intelligent mobile robot may calculate the posture of the forklift through a propagation distance of each laser beam returned by the reflective strip forming the marker and angle information when the laser beam is emitted. For example, according to the orientation and posture of the forklift or the orientation of the fork teeth of the forklift, and in combination with the position information of the forklift and the mounting positions of the fork teeth on the forklift, the specific positions of the fork teeth may be determined.

In one embodiment, a computer device is provided and comprises a memory and a processor. The memory stores a computer instruction executable by the processor. When executed by the processor, the computer instruction causes the steps of the method of the present invention to be performed. The computer device may be broadly a server, a terminal, or any other electronic devices with necessary computing and/or processing capabilities. In one embodiment, the computer device may comprise a processor, a memory, a network interface and a communication interface which are connected through a system bus. The processor of the computer device may be configured to provide necessary computing, processing and/or control capabilities. The memory of the computer device may comprise a nonvolatile storage medium and an internal memory. An operating system and a computer program may be stored in or on the nonvolatile storage medium. The internal memory provides an environment for the operation of the operating system and the computer program in the nonvolatile storage medium. The network interface and the communication interface of the computer device may be configured to be connected to and communicate with an external device through a network. When executed by the processor, the computer program causes the steps of the method of the present invention to be performed.

The present invention may be implemented as a computer-readable storage medium, storing a computer instruction. When executed by a processor, the computer instruction causes the steps of the method of the present invention to be performed. In one embodiment, the computer instruction is distributed on a plurality of computer devices or processors coupled with the network, so that the computer instruction is stored, accessed and executed by one or more computer devices or processors in a distributed manner. The steps/operations of a single method, or the steps/operations of two or more methods may be performed by a single computer device or processor or two or more computer devices or processors. The steps/operations of one or more methods may be performed by one or more computer devices or processors, and the steps/operations of one or more other methods may be performed by one or more other computer devices or processors. One or more computer devices or processors may perform the steps/operations of a single method, or may perform the steps/operations of two or more methods.

Those skilled in the art may understand that the computer instruction may instruct related hardware such as the computer device or processor to implement all or part of the steps of the method of the present invention, the computer instruction may be stored in a non-transitory computer-readable storage medium, and when executed, the computer instruction causes the steps of the method of the present invention to be performed. According to the situation, any reference of a memory, a storage, a database, or other mediums used herein may comprise a nonvolatile memory and/or a volatile memory. The example of the nonvolatile memory comprises a read-only memory (ROM), a programmable ROM (PROM), an electrically programmable ROM (EPROM), an electrically erasable programmable ROM (EEPROM), a flash memory, a magnetic tape, a floppy disk, a magneto-optical data storage apparatus, an optical data storage apparatus, a hard disk and a solid-state disk. The example of the volatile memory may comprise a random access memory (RAM) or an external cache memory.

The technical features described above may be combined arbitrarily. Although all possible combinations of the technical features are not described, any combination of the technical features should be considered as being covered by the specification, as long as there is no contradiction between such combinations.

Although the present invention is described with reference to the embodiments, those skilled in the art should understand that the above description and drawings are only illustrative and not restrictive, and the present invention is not limited to the disclosed embodiments. Various modifications and variations are possible without departing from the spirit of the present invention.

1. A transportation tool, comprising:
a body; and
a bearing component, mounted on the body and extending out of the body,
wherein the body comprises one or more markers formed thereon, at least a part of the one or more markers are located above the bearing component,
at least one of the one or more markers forms a code, and the code is configured to represent information related to the transportation tool.

2. The transportation tool according to claim 1, wherein the information related to the transportation tool comprises:
identity information for identifying an identity of the transportation tool; and/or
face information for identifying each of at least one face of the body.

3. The transportation tool according to claim 1, wherein each of the at least one marker has a same marker part, the same marker part forms an information item code representing one or more information items selected from at least one information item associated with the transportation tool, the at least one information item comprises identity information for identifying an identity of the transportation tool, and for each of the at least one marker, the same marker part is at least a part of the marker.

4. The transportation tool according to claim 3, wherein the at least one information item comprises a model of the transportation tool and/or a serial number of the transportation tool.

5. The transportation tool according to claim 1, wherein the at least one marker comprises a first marker formed on a first face of the body, at least a part of the first marker forms a face code representing the first face where the first marker is located, the face code is configured to identify the first face, and the bearing component is mounted on the first face and extends out of the first face.

6. The transportation tool according to claim 1, wherein the at least one marker comprises at least two markers formed on different faces of the body, respectively; the at least two markers are at least partially different from each other; mutually different parts of the at least two markers respectively form face codes representing faces where the corresponding markers in the at least two markers are located; and each of the face codes is configured to identify the corresponding face.

7. The transportation tool according to claim 1, wherein each of the markers is formed by at least one of a reflective strip for Lidar, a v-marker, a QR code and a bar code.

8. The transportation tool according to claim 1, being a forklift, wherein the body is a body of the forklift, and the bearing component is fork teeth of the forklift.

9. A method for interaction between an intelligent mobile robot and the transportation tool according to claim 1, comprising the following steps performed by the intelligent mobile robot:
a detection step, comprising: detecting the at least one marker to detect the transportation tool and identify information related to the transportation tool; and
a processing step, comprising: performing an operation based on the identified information in response to the transportation tool being detected.

10. The method according to claim 9, wherein the operation comprises a docking operation or an obstacle-avoiding operation;
the information related to the transportation tool comprises identity information for identifying the identity of the transportation tool; and the processing step comprises:
determining whether the transportation tool is a target docking object of the intelligent mobile robot based on the identity information; performing the docking operation to dock with the transportation tool in a case where the transportation tool is a target docking object of the intelligent mobile robot; and performing the obstacle-avoiding operation to avoid the transportation tool in a case where the transportation tool is not a target docking object of the intelligent mobile robot, and/or
determining a type of the transportation tool, a size of the transportation tool and/or a size of the bearing component based on the identity information; performing the docking operation based on the type of the transportation tool, the size of the transportation tool and/or the size of the bearing component in a case of performing the docking operation; performing the obstacle-avoiding operation based on the type of the transportation tool, the size of the transportation tool and/or the size of the bearing component in a case of performing the obstacle-avoiding operation;
and/or
the information related to the transportation tool comprises face information for identifying each of at least one face of the body, and the processing step comprises:
determining an orientation of the transportation tool, a posture of the transportation tool and/or an orientation of the bearing component based on the face information; performing the docking operation based on the orientation of the transportation tool, the posture of the transportation tool and/or the orientation of the bearing component in a case of performing the docking operation; performing the obstacle-avoiding operation based on the orientation of the transportation tool, the posture of the transportation tool and/or the orientation of the bearing component in a case of performing the obstacle-avoiding operation.

11. A system comprising a plurality of transportation tools, wherein each of the plurality of transportation tools is the transportation tool according to claim 1.

12. The system according to claim 11, wherein the plurality of transportation tools have different serial numbers, and/or the plurality of transportation tools comprise transportation tools of a same model or a plurality of different models.

13. The system according to claim 11, wherein
each of the plurality of transportation tools is the transportation tool according to claim 3 or 4; for the each of the plurality of transportation tools, the each transportation tool comprises:
a body; and
a bearing component, mounted on the body and extending out of the body,
wherein the body comprises one or more markers formed thereon, at least a part of the one or more markers are located above the bearing component,
at least one of the one or more markers forms a code, and the code is configured to represent information related to the transportation tool,
each of the at least one marker has a same marker part, the same marker part forms an information item code representing one or more information items selected from at least one information item associated with the transportation tool, the at least one information item comprises identity information for identifying an identity of the transportation tool, and for each of the at least one marker, the same marker part is at least a part of the marker, and
the information item code thereon is a binary code, and a number of bits of the binary code depends on the one or more information items represented by the information item code.

14. (canceled)

15. (canceled)

16. The system according to claim 11, wherein
for the each of the plurality of transportation tools, the each transportation tool comprises:
a body; and
a bearing component, mounted on the body and extending out of the body,
wherein the body comprises one or more markers formed thereon, at least a part of the one or more markers are located above the bearing component,
at least one of the one or more markers forms a code, and the code is configured to represent information related to the transportation tool,
the at least one marker comprises a first marker formed on a first face of the body, at least a part of the first marker forms a face code representing the first face where the first marker is located, the face code is configured to identify the first face, and the bearing component is mounted on the first face and extends out of the first face, and
the face code thereon is a 2-bit binary code.
